(19) United States
(12) Patent Application Publication
(10) Pub. No.: US 2013/0045303 A1
(43) Pub. Date: Feb. 21, 2013

(54) FROZEN DOUGH FOR MICROWAVEABLE FOOD, ITS PREPARING METHOD AND THE USE THEREOF FOR PROCESSING MICROWAVABLE FRIED FRITTERS

(71) Applicants: Wei Chen, Wuxi (CN); Daming Fan, Wuxi (CN); Hao Zhang, Wuxi (CN); Jianxin Zhao, Wuxi (CN); Fengwei Tian, Wuxi (CN)

(72) Inventors: Wei Chen, Wuxi (CN); Daming Fan, Wuxi (CN); Hao Zhang, Wuxi (CN); Jianxin Zhao, Wuxi (CN); Fengwei Tian, Wuxi (CN)

(21) Appl. No.: 13/502,339

(22) PCT Filed: Jun. 7, 2010
(86) PCT No.: PCT/CN2010/073604

§ 371 Date: Oct. 16, 2012

(30) Foreign Application Priority Data
Apr. 9, 2010 (CN) 201010142846.0
Apr. 9, 2010 (CN) 201010142848.X
Apr. 9, 2010 (CN) 201020154081.8
Apr. 9, 2010 (CN) 201020154083.7

(51) Int. Cl. A21D 8/02; A21D 10/00; A21D 15/02; A21D 2/02

(52) U.S. Cl. 426/26; 426/551; 426/439

(57) ABSTRACT

The present invention relates to the manufacturing and preparation of frozen dough, and its application in microwaveable fried food. The preparation of fried fritters comprises the following steps: disposal of raw materials, dough kneading, dough proofing for the first time, dough folding, dough proofing for the second time, making blanks, frying and quick-freezing. Alum as the acidic component in leavening agents is replaced by a complex formulation of gluconic acid-δ-lactone, glycerol monolaurate and calcium dihydrogen phosphate, thus reducing the toxicity of the dough. The fried fritters preparing by the dough of the present invention possess a good expansion rate, crispness and taste, and should satisfy consumer demands for quality food products that can be reheated by microwaving. The process outlined here can make the manufacturing of traditional fried fritters simpler and more convenient so should be easy to develop commercially and should generate solid economic benefits.

The present application claims the priority of the Chinese patent application CN 201010142846.0 (The preparation method of the quick-freezing fried fritter), CN 201010142848.X (Frozen dough and its preparation and application), CN 201020154081.8 (Fritter blank continuous molding and jointing device) and CN 201020154083.7 (Far-infrared continuous fried fritter frying machine) submitted on 9 Apr. 2010.

### FIELD OF INVENTION

The present invention relates to the manufacturing of flour products. More specifically, the present invention relates to a kind of frozen dough for use in microwaveable food, and to the preparation of the said frozen dough and its application in the manufacturing of microwaveable fried food.

### BACKGROUND OF THE INVENTION

The frozen dough technique is a bread processing technology developed in the 1950s, which divides flour product processing into two stages: dough making and product processing. With the development of processing techniques, the frozen dough technique is now used in nearly all areas of pastry processing. The technique has developed and matured with the growth of chain stores and fast food restaurants. Moreover, flour-based foods now make up a greater proportion of the domestic food market. The nature of dough directly affects the quality of flour products. As a result, dough used in quick-frozen flour-based foods which meets traditional Chinese characteristics will have a broad market appeal.

As an essential component of quick-frozen flour foods, dough has a vast market share. However, due to the great variety of flour-based foods and dough's diverse functions in these products, dough must be prepared with different raw materials depending on the specific products, and be processed immediately or after refrigeration. Dough made with traditional ingredients is unsuitable for quick-frozen fried foods because of the phenomenon of ice crystal formation in the pores of the dough during freezing, which can damage the product. Taking the fried fritter as an example, the inhomogeneous internal structure of the product and uneven temperature of freezing or slow drop in temperature will induce bigger ice crystals to form from moisture trapped in the product, which will have a destructive effect on the bubble wall. Alternatively, the inadequate yield stress of the products themselves will cause bursting when subjected to external forces. These issues are closely connected with the make-up of the dough which determines the internal structure and yield stress of products. For example, ductility and resistance to extension is linked to the ability of the dough to retain gases on a macro scale, while rheologically tested yield stress and deformation can reflect surface tension on a micro scale. As a result, testing the dough can establish its suitability for a given product. Alum (hydrated potassium aluminum sulfate) may need to be added as an acid leavening agent, to form flocculent aluminum hydroxide which fills in the gluten units, increasing the dough's ductility and resistance to extension and improving its operability and gas retention. However, aluminum is not easily metabolized by the human body. Some studies have shown that aluminum deposits in the human body can lead to osteoporosis, memory decay, and poorer skin elasticity. Intake of aluminum is linked to senile dementia. Moreover, in 1987, the World Health Organization identified aluminum as a food pollutant (Dong et al, Optimization of the bulking agent without aluminum of dough-strips, Journal of Henan University of Technology, 2005, 26(2):33-35).

To solve the above problems, manufacturers have adopted alternative reagents and processes, as follows. (1) Alum is replaced with phosphate, potassium hydrogen tartrate or citric acid. Although this method can generate the necessary gas for processing, significant volumes of reagent are required which raises costs. Furthermore, the violent reaction between the acidic ingredients and sodium bicarbonate can accelerate the release of gas which interferes with the production process, and can lead to malodorous fried fritters. For example, compound leavening agents developed by Xue et al. (1996) solved a number of problems but were needed in excess amounts. In the optimal formulation, the leavening agent was 10.3% by weight of the flour. Excess leavening agent not only triggers bad odors, but can lead to excess human intake of salt (Xue et al, Optimization experimental investigations on formulation of without aluminum leavening agents in fried pastry foods, Food Science, 1996, 157, 5:48-55). (2) Along with the compound leavening agents, eggs are added to change the characteristics of the dough and favor the formation of bubbles (Wang and Ding, The development of formulation of without aluminum egg fried fritter, Science and Technology of Cereals, Oils and Foods, 2006, 14(1):32-42), which generates a fried fritter with a crisp, golden surface. (3) The fried fritter is produced by fermenting yeast to generate gases which can increase the number of bubbles formed, decrease the volume per bubble and raise the textural strength of the finished fried fritter. However, these methods cannot solve the problem of rupturing in quick-frozen products.

With the surge in popularity of domestic microwave ovens, microwaveable food has harnessed a considerable market share. However, few microwaveable baked goods are for sale and there is even less research on microwaveable bakery foods produced with frozen dough. This stems from the nature of microwave heating itself. Microwaves can penetrate objects and heat their inside and outside simultaneously. Traditional baking needs a heat transfer medium to transfer heat to food, while microwaves act directly on polar molecules inside the food which shortens the heating time, improving thermal efficiency and saving energy. Shorter heating times can also help prevent the loss of nutrients and moisture from the food.

However, microwave heating has some shortcomings. Firstly, the temperature on the surface of food may not be raised sufficiently high to trigger the Maillard or caramelization reaction, which is responsible for the attractive golden brown sheen seen on traditional baked goods. Secondly, microwaving requires highly accurate heating of the food, where a slightly longer heating time can lead to irreversible effects from over-heating. Microwave heating can also be uneven.

Nevertheless, given the overall advantages of microwaving, it is worth developing quick-frozen food based on frozen dough fit for microwave heating.

The present invention uses gluconic acid-δ-lactone, calcium phosphate, glycerol monolaurate and sodium bicarbonate as leavening agents and quality improvers and develops frozen dough to produce microwaveable quick-frozen fried fritters without aluminum, along with the processing methods and equipment used on the production line. By replacing alum the amount of additive is minimized, whilst the textural properties, continuity of processing and stability of the batches are improved, generating high quality products.

### DETAILED DESCRIPTION OF THE INVENTION

### Technical Question to be Solved

One objective of the present invention is to provide a type of frozen dough suitable for use in microwaveable food.

Another objective of the present invention is to provide a preparation method for the frozen dough to be use in microwaveable food.

Another objective of the present invention is to provide a method of using the above-mentioned frozen dough in the manufacturing of microwaveable fried food.

[Technical Plan]

The invention adopts the following technical solutions.

The present invention relates to a process for preparing frozen dough to be used in microwaveable food. The said process comprises the following steps:

(I) Disposal of Raw Materials

By weight, accurately weighing and adding 0.6-1.0 parts gluconic acid-δ-lactone, 0.6-1.2 parts calcium dihydrogen phosphate, 3.5-5.5 parts sodium bicarbonate and 8-10 parts sodium chloride to 280-300 parts water at around 40° C., to obtain an aqueous phase; then adding 0.6-1.2 parts glycerol monolaurate to 12.0-13.0 parts edible oil and stirring to dissolve it completely, to obtain an oil phase; subsequently adding the said oil phase to the aqueous phase and stirring for 1-5 min to obtain a liquid mixture.

(II) Dough Kneading

By weight, weighing 480-520 parts flour, and adding the liquid mixture obtained in step (I) three or four times into the flour, then stirring and mixing for 3-8 min to obtain a smooth, springy and sticky dough.

(III) Dough Proofing for the First Time

Sealing the dough obtained in step (II) with plastic wrap, then placing it in a proofer at 40° C. to proof for the first time for 0.8-1.2 hours.

(IV) Dough Folding

Folding the proofed dough obtained in step (III) from two sides to the center, then rotating by 90° and folding again, and repeating the operation 8 to 12 times.

(V) Dough Proofing for the Second Time

Sealing the dough obtained in step (IV) with plastic wrap then placing it in a proofer at 40° C. to proof for the second time for 1.6-2.4 hours, and the proofed dough being directly used for subsequent processing, or frozen to preserve it then thawed prior to subsequent processing.

Another version of the invention uses the following raw materials by weight to prepare the said frozen dough:

| | | |
|---|---|---|
| 0.8-1.0 | parts | gluconic acid-δ-lactone |
| 3.5-5.0 | parts | sodium bicarbonate |
| 0.8-1.0 | parts | glycerol monolaurate |
| 0.8-1.0 | parts | calcium dihydrogen phosphate |
| 12.0-13.0 | parts | edible oil |
| 8.0-10.0 | parts | sodium chloride |
| 480-520 | parts | flour. |

Alternatively, by weight the following raw materials can be used:

| | | |
|---|---|---|
| 1.0 | parts | gluconic acid-δ-lactone |
| 4.5 | parts | sodium bicarbonate |
| 0.8 | parts | glycerol monolaurate |
| 0.8 | parts | calcium dihydrogen phosphate |
| 12.5 | parts | edible oil |
| 9.0 | parts | sodium chloride |
| 500 | parts | flour. |

In a further version of the present invention, freezing in step (V) refers to rapidly freezing the proofed dough for the second time at a temperature of −40° C. and then preserving it at a temperature of −18° C.

In another embodiment of the present invention, the said frozen proofed dough is thawed for 16-20 hours at 4° C. and then proofed in a proofer at a temperature of 27-29° C. and relative humidity of 70-75%; or the said frozen proofed dough is proofed directly in a proofer at a temperature of 27-29° C. and relative humidity of 70-75%.

The invention also relates to the frozen dough prepared according to the method of the invention, characterized in that by weight, it contains the following components:

| | |
|---|---|
| 0.6-1.0 parts | gluconic acid-δ-lactone |
| 3.5-5.5 parts | sodium bicarbonate |
| 0.6-1.2 parts | glycerol monolaurate |
| 0.6-1.2 parts | calcium dihydrogen phosphate |
| 12.0-13.0 parts | edible oil |
| 8.0-10.0 parts | sodium chloride |
| 480-520 parts | flour. |

The invention also relates to the process for preparing a new type of aluminum-free fried fritter using the above-described frozen dough, characterized in that its steps are as follows:

(I) Pouring the blended oil or other light oil into a frying pan and maintaining the temperature of the oil at 200° C. using a temperature controller.

(II) Making blanks

Making the said dough into blanks 0.6-0.8 cm thick, and then cutting them into pieces 8-12 cm long and 2.0-3.0 cm wide; or making the said dough into blanks using a fritter blank continuous molding and jointing device.

(III) Frying

Laying two blanks together with chopsticks pressing their center lengthwise, then lengthening them with a homogeneous force and placing them in a frying pan or far-infrared (FIR) continuous fried fritter frying machine, from which the said fried fritters come out; or directly connecting the fritter blank continuous molding and jointing device with the FIR continuous fried fritter frying machine to execute the frying operation.

According to an embodiment of the process for preparing a new type of aluminum-free fried fritter, fried fritters obtained by frying are placed for 3 min in a sieve or grid conveyor to remove excess oil, then transferred to a precooling tunnel or room with a temperature of 20° C. and wind speed of 200 m/min to be cooled for 30 min, after which the fried fritters are transferred to the quick-freezing room at a temperature of −35° C. or quick-freezing tunnel at a temperature of −30° C. to be rapidly frozen over 5-10 min; when the temperature of their center drops below −18° C., the fried fritters are deemed frozen and preserved at a temperature of −20° C.

In the preparation of the new type of aluminum-free fried fritter, the said fritter blank continuous molding and jointing device consists of a frame, with conveyors mounted on the table of the said frame driven by a motor and driving wheels, taking the traveling direction of the materials as the front. Two pressure mechanisms are installed in succession on the said frame, with carrying plates separately equipped above the pressure mechanisms. In front of the said pressure mechanisms are located an extrusion unit and a transverse cutting unit. A dusting unit is mounted after the said pressure mechanisms, with two conical atomizing nozzles used to spray a solution that bonds two flour bands centered at the pressure mechanisms. A thinning mechanism used to quickly thin the dough is located between the said extrusion unit and transverse cutting unit, along with a screw press roller between the said thinning mechanism and transverse cutting unit, and a flour recovery tank underneath the forefront of the said conveyors.

According to an embodiment of the process for preparing the new type of aluminum-free fried fritter, the said FIR continuous fried fritter frying machine consists of the body, an oil tank installed inside the said body, and the oil pocket system and control box integrated system connected to the said oil tank. The said oil tank is in a “boat” style and is located above the said body, along with a transmission-warming integrated device controlled by a hydraulic structure. A conveyor and chain-mode conveyor driven by a motor are installed inside the said integrated device, and the said conveyor equipped with an extruding roller to carry the fried fritters is installed around the head and end driving wheels of the transmission-warming integrated device. The said chain-mode conveyor is installed inside the transmission-warming integrated device and around two sets of driving wheels, and engages with the end socket gears of the extruding roller of the said conveyor. Infrared heating tubes and/or infrared heating plates are installed in the middle of the said chain-mode conveyor and an oil level sensor is located on the side of the “boat body”.

With the frozen dough, we can produce not only a new type of aluminum-free fried fritter, but also aluminum-free Pai Cha, fried noodle fish, crackers, or fried dough twists.

The present invention is described in more detail below.

The present invention relates to a process for preparing frozen dough. The said process comprises the following steps:

(I) Disposal of Raw Materials

By weight, accurately weighing and adding 0.6-1.0 parts gluconic acid-δ-lactone, 0.6-1.2 parts calcium dihydrogen phosphate, 3.5-5.5 parts sodium bicarbonate and 8-10 parts sodium chloride to 280-300 parts water at around 40° C., to obtain an aqueous phase; then adding 0.6-1.2 parts glycerol monolaurate to 12.0-13.0 parts edible oil and stirring to dissolve it completely, to obtain an oil phase; subsequently adding the said oil phase to the aqueous phase and stirring for 1-5 min to obtain a liquid mixture.

In the invention, the said gluconic acid-δ-lactone is obtained by the carboxyl group on the gluconic acid being esterified with the hydroxyl group on the δ position. Its molecular weight is 178.14, and it forms a white crystal or crystalline powder with a faint fragrance that is sweet to slightly sour. Its melting point is 148-150° C. and it can be decomposed into gluconic acid at 153° C. Gluconic acid-δ-lactone is soluble in water (59 g/100 mL water) and slightly soluble in ethanol. When it makes contact with water, the molecule can be hydrolyzed into gluconic acid and can release hydrogen ions; it can be completely metabolized by the human body to provide energy. The said gluconic acid-δ-lactone is widely used as a fermenting agent, acidifying agent, color retention agent and protein coagulant. In the present invention, the said gluconic acid-δ-lactone is now a commercially available product, for example sold under the trademark name XZFOOD by Xingzhou Medicine Food Co. Ltd, Anhui Province, or gluconic acid-δ-lactone type FCCIV sold by Guanyi Food Additive Co. Ltd, Jiangxi Province.

In this invention sodium bicarbonate, also known as baking soda, is a basic ingredient that reacts with acidic ingredients to produce gas. Sodium bicarbonate can also accelerate the dough's development while lowering its resistance to extension, which aids the processing operation. Finally, sodium bicarbonate can neutralize the acidic ingredients in the food to enhance flavor and simultaneously increase human intake of alkali to help maintain the body's alkalinity. Sodium bicarbonate is now a commercially available product, such as food-grade sodium bicarbonate sold by Beijing Shanfeng Hongsheng Chemical Co. Ltd and Tianjin Jinhui Taiya Chemical Reagent Co. Ltd.

In the invention, glycerol monolaurate (GML) is a lipophilic non-ionic surfactant with preserving and emulsifying functions. The minimum concentration at which glycerol monolaurate inhibits fungal or bacterial activity is less than that of butyl p-hydroxybenzoate (butyl p-hydroxybenzoate has the strongest antimicrobial ability of all the p-hydroxybenzoate preservatives, but has not yet been approved for use in food in China, while China has given approval to ethyl and propyl p-hydroxybenzoate for use in food), and much less than that of sorbic acid, which means glycerol monolaurate is more potent against common fungi and bacteria in food than p-hydroxybenzoate, and far stronger than the more widely used food preservative of sorbic acid. Moreover, glycerol monolaurate does not adversely affect food flavor at concentrations of up to 500 ppm. However, in the food industry, the amount of glycerol monolaurate generally added is 1,000 to 2,000 ppm (0.10-0.2%) which is suitable for bread and baked foods, cheeses, margarine, dairy products, surimi, sausage and fruit and vegetable and does not have an adverse effect on the above-mentioned foods. Along with its ability to preserve food, GML also has an emulsifying function and can change the crystallization rate, reduce the mixing time, and improve the taste, shape retention and storage stability of ice cream. GML can also be used in cake and dairy products. In this invention, the said glycerol monolaurate is now a commercially available product, such as type p1-9001 sold by Zhengzhou Pinli Food Co. Ltd.

In the present invention, the said calcium dihydrogen phosphate is generally used as dough conditioner and texture improver. In the process of making bread or steamed buns, calcium dihydrogen phosphate will harden the surface of products and affect the taste of the bread and steamed buns. Consequently, this component is used to enhance internal hardness and surface brittleness. In this invention, the said calcium dihydrogen phosphate is now a commercially available product, such as the food-grade product sold by Shanghai Yanxin Chemical Co. Ltd and Lianyungang Hensheng Fine Chemical Co. Ltd.

The said edible oil is an important energy supply for the human body, and can be stored in the body to help maintain essential activities. In this invention, the said edible oil is of the type used in everyday cooking such as soybean oil, sunflower oil, corn oil or peanut oil.

One version of the invention uses the following raw materials by weight to prepare the frozen dough:

| | |
|---|---|
| 0.8-1.0 parts | gluconic acid-δ-lactone |
| 3.5-5.0 parts | sodium bicarbonate |
| 0.8-1.0 parts | glycerol monolaurate |
| 0.8-1.0 parts | calcium dihydrogen phosphate |
| 12.0-13.0 parts | edible oil |
| 8.0-10.0 parts | sodium chloride |
| 480-520 parts | flour. |

Alternatively, by weight the following raw materials can be used:

| | |
|---|---|
| 1.0 parts | gluconic acid-δ-lactone |
| 4.5 parts | sodium bicarbonate |
| 0.8 parts | glycerol monolaurate |
| 0.8 parts | calcium dihydrogen phosphate |
| 12.5 parts | edible oil |
| 9.0 parts | sodium chloride |
| 500 parts | flour. |

(II) Dough Kneading

By weight, weighing 480-520 parts flour, and adding the liquid mixture obtained in step (I) three or four times to the said flour, then stirring and mixing for 3-8 min to obtain a smooth, springy and sticky dough.

In the invention, the dough mixer or any well-known artificial kneading method can be used to carry out the said dough kneading. The said dough mixer is now a commercially available product, such as those sold under the trade name OMJ-120 by Oumeijia Food Machinery Company.

Preferably, the liquid mixture obtained in step (I) is mixed with the said flour for 4-6 min.

(III) Dough Proofing for the First Time

Sealing the dough obtained in step (II) with plastic wrap, then placing it in a proofer at 40° C. to proof for the first time for 0.8-1.2 hours.

In the present invention, dough proofing for the second time should be taken to be fermentation of the proofed dough; for the unproofed dough, dough proofing involves the kneaded dough being covered by a plastic wrap or wet cloth and left to stand for some time, so that the gluten in the flour can help to increase the strength of the dough, which in turn leads to more tender and better tasting food products.

In this invention, the said proofer is now a commercially available product, such as those sold by Zhangqiu City Luxing Machine Works or Wuxi Oumai Machinery Co. Ltd.

(IV) Dough Folding

Folding the proofed dough obtained in step (III) from two sides to the center, then rotating by 90° and folding again, and repeating the operation 8 to 12 times.

The number of times the folding operation is repeated is not critical and may be altered.

Preferably, folding of the proofed dough is repeated 10 times.

(V) Dough Proofing for the Second Time

Sealing the dough obtained in step (IV) with plastic wrap, then placing it in a proofer at 40° C. to proof for the second time for 1.6-2.4 hours, and the proofed dough being directly used for subsequent processing, or frozen to preserve it then thawed prior to subsequent processing.

The proofer used for proofing for the second time is the same as that used the first time.

In another version of the invention, the freezing in step (V) aims to ensure the dough is quick-frozen at a temperature of −40° C. and wind speed of 1 m/s, under which conditions the center of the dough freezes at a rate of −0.17° C./min, after which the dough is preserved at a temperature of −18° C.

According to another embodiment of the process for preparing the frozen dough, the said frozen dough is thawed for 16-20 hours at a temperature of 4° C. and then proofed in a proofer at a temperature of 27-29° C. and relative humidity of 70-75%; or the said frozen dough is proofed directly in a proofer at a temperature of 27-29° C. and relative humidity of 70-75%.

In this invention, the freezing equipment such as refrigerators or freezing tunnels used to carry out the said freezing are commercially available, such as the appliances sold by Shaoxing Gaojin Refrigeration Air-conditioning Equipment Co. Ltd, or Shanghai Aeroasia Freezer Co. Ltd.

The present invention also relates to the frozen dough prepared according to the method of the invention, characterized in that by weight, it contains the following components:

| | |
|---|---|
| 0.6-1.0 parts | gluconic acid-δ-lactone |
| 3.5-5.5 parts | sodium bicarbonate |
| 0.6-1.2 parts | glycerol monolaurate |
| 0.6-1.2 parts | calcium dihydrogen phosphate |
| 12.0-13.0 parts | edible oil |
| 8.0-10.0 parts | sodium chloride |
| 480-520 parts | flour. |

In the next section, we explain in detail the impact of the different ingredients on the nature of the dough.

### EXPERIMENTAL METHOD

### 1. Farinographic and Extensorgraphic Measurements

The flour with known humidity was accurately weighed according to the corresponding value given by GB/T 14614-93. Ingredients were accurately weighed respectively. The experiment was carried out by following the procedures of GB/T 14614-93 and GB/T 14615-93.

The farinographic and extensorgraphic properties were measured using instruments similar to the Farinograph-E and Extensograph-E instruments sold by Brabender in Germany or JFZD products sold by Beijing Dongfang Fude Technology Development Center.

### 2. Measurement of Rheological Properties

Firstly, 10 g of the mixed ingredients in powder form was accurately weighed and made it into the dough according to the water absorption measured by the farinograph and extensorgraph experiment. Then the prepared dough was proofed for 20 min in a proofer at a temperature of 30° C. From this, 5 g of dough was accurately weighed for trial use.

The rheometer used in this test was an AR-G2 type instrument from TA Instruments, USA.

The measurement conditions of the rheometer were as follows: a tablet with a diameter of 40 mm was placed under the probe, the gap was set to 2 mm and the temperature to 30° C.

The experiment was conducted as follows.

Gradually alter the stress from 0 Pa to 2,000 Pa, then determine the linear viscoelastic range of the dough, where the stress in the creep recovery test is 300 Pa. Carry out a scan over the angular frequency range of 1-100 rad/s to explore how the composite modulus of the dough changes with angular frequency. At the end, carry out the creep recovery test under a stress of 300 Pa and creep time of 2 min, to establish the yield stress and viscoelasticity of dough.

Results of the Experiment

1. The effect of gluconic acid-δ-lactone on the farinographic and extensorgraphic properties of the frozen pre-fried dough

TABLE 1
The effect of gluconic acid-δ-lactone on the farinographic and
extensorgraphic properties of the dough

| | | | Degree | Maximum | | | |
|---|---|---|---|---|---|---|---|
| Gluconic | | Stability | of | extension | | Extension | |
| acid-δ-lactone | Development | time | softening | resistance | Extension | area | Extensibility |
| (g) | time (min) | (min) | (FU) | (BU) | ratio | (cm²) | (mm) |
| blank | 48.6 | 57.8 | 12 | 818.0 | 4.10 | 207.0 | 200.0 |
| 0.2 | 29.8 | 58.5 | 8 | 969.0 | 5.27 | 223.3 | 185.0 |
| 0.4 | 25.9 | 50.1 | 8 | 964.3 | 5.10 | 227.0 | 189.3 |
| 0.6 | 23.3 | 48.1 | 9 | 963.7 | 5.20 | 223.3 | 186.7 |
| 0.8 | 21.2 | 37.2 | 3 | 1070.3 | 6.37 | 222.3 | 172.3 |
| 1.0 | 19.3 | 38.1 | 29 | 1088.3 | 6.57 | 222.3 | 169.3 |

In Table 1, development time represents the time taken from adding water to the flour for the farinograph to achieve and maintain the maximum consistency. Stability time represents the time difference, during the dough kneading process, between the time corresponding to one intersection of the farinograph with the 500 FU line before its peak value and that corresponding to another intersection of the declining farinograph with the 500 FU line. Degree of softening represents the difference between the midline value of the farinograph at the maximum consistency obtained from the dough's development and the midline value of the farinograph obtained at the consistency of dough at 12 min. Maximum extension resistance represents the maximum height Rₘ of the extension curve. Extension ratio represents the ratio of maximum extension resistance to extensibility. Extension area represents the area enclosed by the extension curve and measured with a planimeter. Extensibility represents the distance between the abscissa point on the extension curve which corresponds to the hook making contact with the dough and the point which corresponds to the dough being pulled off.

The results in Table 1 show that, relative to the blank, gluconic acid-δ-lactone can significantly reduce the dough's development time, stability time and extensibility, and increase its extension resistance, extension ratio and extension area. Moreover, this effect increases with increasing levels of gluconic acid-δ-lactone. However, when less than 0.6 g is added, the extension resistance and ratio do not change significantly; when 1.0 g is added, the degree of softening increases dramatically. Therefore, the optimum amount of gluconic acid-δ-lactone to add is 0.6-1.0 g, or 0.075-0.125% by weight of dough.

2. The effect of calcium dihydrogen phosphate on the farinographic and extensorgraphic properties of dough

TABLE 2
The effect of calcium dihydrogen phosphate on the farinographic
and extensorgraphic properties of the dough

| Calcium | | | Degree | Maximum | | | |
|---|---|---|---|---|---|---|---|
| dihydrogen | | Stability | of | extension | | Extension | |
| phosphate | Development | time | softening | resistance | Extension | area | Extension |
| (g) | time (min) | (min) | (FU) | (BU) | ratio | (cm²) | (mm) |
| Blank | 48.6 | 57.8 | 12 | 818.0 | 4.10 | 207.0 | 200.0 |
| 0.2 | 36.3 | 58.4 | 12 | 936.7 | 4.83 | 230.7 | 195.3 |
| 0.4 | 40.2 | 55.0 | 7 | 985.7 | 5.37 | 227.0 | 185.3 |
| 0.6 | 43.8 | 58.1 | 8 | 1040.0 | 5.90 | 231.7 | 178.7 |
| 0.8 | 24.0 | 52.5 | 8 | 1122.0 | 6.83 | 229.0 | 165.7 |
| 1.0 | 24.7 | 51.5 | 9 | 1175.3 | 7.47 | 227.7 | 161.0 |

The terms in Table 2 are defined as for Table 1.

The results in Table 2 show that, relative to the blank, calcium dihydrogen phosphate can significantly reduce the dough's development time, stability time and extensibility, and increase the extension resistance, extension ratio and extension area. Moreover, this effect increases with increasing levels of calcium dihydrogen phosphate. However, when less than 0.6 g is added, the development time, stability time and extension area do not change significantly, while the degree of softening decreases significantly; above this amount, development time decreases dramatically which can effectively shorten the production time; when the amount exceeds 1.0 g, development time and degree of softening start to increase which is likely to have a negative effect on the production process. Therefore, the optimum amount of calcium dihydrogen phosphate to add is 0.6-1.2 g, or 0.075-0.15% by weight of dough.

3. The effect of glycerol monolaurate on the farinographic and extensorgraphic properties of dough

TABLE 3
The effect of glycerol monolaurate on the farinographic and
extensorgraphic properties of the dough

| | | | Degree | Maximum | | | |
|---|---|---|---|---|---|---|---|
| Glycerol | | Stability | of | extension | | Extension | |
| monolaurate | Development | time | softening | resistance | Extension | area | Extension |
| (g) | time (min) | (min) | (FU) | (BU) | ratio | (cm²) | (mm) |
| Blank | 48.6 | 57.8 | 12 | 818.0 | 4.10 | 207.0 | 200.0 |
| 0.3 | 46.8 | 58.4 | 7 | 1160.3 | 6.93 | 244.3 | 172.7 |
| 0.6 | 30.5 | 58.3 | 7 | 1133.3 | 6.23 | 259.0 | 185.3 |
| 0.9 | 31.7 | 58.2 | 10 | 1095.3 | 5.77 | 259.3 | 191.3 |
| 1.2 | 42.3 | 57.9 | 12 | 999.0 | 5.37 | 231.0 | 188.7 |
| 1.5 | 39.3 | 58.3 | 13 | 954.7 | 5.10 | 228.0 | 189.0 |

The terms in Table 3 are defined as above.

The results in Table 3 show that, relative to the blank, glycerol monolaurate can initially increase the extension resistance, extension ratio, extension area and degree of softening. However, these decrease dramatically with increasing levels of GML. The reverse pattern is evident for development time and extensibility. When less than 0.6 g is added, development time does not significantly change while degree of softening declines substantially. When 1.2 g is added, development time rises sharply (from that at 0.9 g) while degree of softening returns to the level in the blank sample. Therefore, the optimal amount of glycerol monolaurate to add is 0.6-1.2 g, or 0.2-0.4% by weight of dough.

4. The collective effect of all ingredients on the farinographic and extensorgraphic properties of dough

TABLE 4
The effect of all ingredients on the farinographic and
extensorgraphic properties of the dough

| | | | Degree | Maximum | | | |
|---|---|---|---|---|---|---|---|
| All | | Stability | of | extension | | Extension | |
| ingredients | Development | time | softening | resistance | Extension | area | Extension |
| (g) | time (min) | (min) | (FU) | (BU) | ratio | (cm²) | (mm) |
| With alum | 33.5 | 29.5 | 69 | 1257 | 8.3 | 232 | 154 |
| With | 31.3 | 30.2 | 80 | 1024 | 5.4 | 243 | 189 |
| lactone | | | | | | | |

Conventional dough is composed of 0.8 g of alum, 7 g of ammonium bicarbonate, 2.25 g of sodium bicarbonate and 1.25 g of calcium dihydrogen phosphate per 500 g of flour. Our invention is composed of 1.0 g of gluconic acid-δ-lactone, 0.8 g of glycerol monolaurate, 4.5 g of sodium bicarbonate and 0.8 g of calcium dihydrogen phosphate per 500 g of flour.

The above results show that in terms of development time, stability time and degree of softening, the formulation of the present invention (with lactone) is similar to conventional dough made with alum. In terms of tensile properties, the present invention can increase the extension resistance and ratio while decreasing the extension area and extensibility of the dough, compared to the formulation containing alum.

5. The effect of the lactone-based and alum-based formulations on the composite modulus (G*) of dough

The results of the analysis of the said dough over the angular frequency of 1-100 rad/s are shown in FIG. 1.

Frequency scanning can indicate the elastic modulus, viscous modulus and composite modulus of dough. FIG. 1 shows that, as the angular frequency increases, the complex modulus (G*) changes significantly (P<0.0001). In the same angular frequency range, the dough of the lactone formulation has a higher G* than that of the alum formulation by about 6,000 Pa, which means the lactone formulation generates dough with better fluid and extension properties. In terms of elasticity, both formulations show a similar trend with G* increasing with angular frequency.

6. The effect of individual ingredients on the composite modulus (G*) of dough

The scanning results over the angular frequency range of 1-100 rad/s per individual ingredient are shown in FIG. 2. FIG. 2 shows that, as the angular frequency increases, G* changes significantly (P<0.0001). G* values in descending order are: calcium dihydrogen phosphate, alum, glycerol monolaurate, blank and gluconic acid-δ-lactone. Only gluconic acid-δ-lactone has a lower G* value than the blank, which means gluconic acid-δ-lactone can increase the mobility and ductility of dough. As G* increases with angular frequency, elasticity increases. Thus, alum and calcium dihydrogen phosphate can both significantly increase the G* value, elasticity and the deformation resistance of dough. At higher angular frequencies, adding glycerol monolaurate has no significant effect on the G* value compared to the blank. Glycerol monolaurate normally reduces the flexibility of the dough, where a small amount of glycerol monolaurate can promote gluten protein cross-linking, while excess glycerol monolaurate will promote the combining of gluten protein and other hydrophobic substances such as oils, preventing the gluten from combining with water and thus reducing its strength. Nevertheless, excess glycerol monolaurate is optimal for our formula, as determined by the orthogonal experiment (see Table 7). Thus, we can obtain the same viscoelasticity as that of conventional alum-based dough by adjusting the levels of gluconic acid-δ-lactone, calcium dihydrogen phosphate and glycerol monolaurate.

7. The effect of all the ingredients on the creep recovery of dough

The results of the creep recovery test under a stress of 300 Pa are shown in FIG. 3.

The creep recovery experiments reflect the yield stress, elasticity ratio and maximum viscosity of dough. FIG. 3 shows that alum-based dough has a slightly higher deformation value than the dough of the present invention, suggesting it is more prone to deformation, that is, its deformation resistance is lower. We calculated the characteristics of the conventional dough as follows: maximum viscosity of 2.5×10⁶ Pa s, maximum yield stress of 1.825×10⁻⁴ Pa⁻¹, and elasticity ratio of 51.51%. The characteristics of the lactone-based dough are as follows: maximum viscosity of 3.0×10⁶ Pa s, maximum yield stress of 1.5×10⁻⁴ Pa⁻¹, and elasticity ratio of 53.33%. Thus, conventional dough has a lower elasticity ratio, higher yield stress and lower viscosity than lactone-based dough. Overall, the two kinds of dough have a similar elasticity ratio and yield stress, but a slight difference in viscosity.

8. The effect of individual ingredients on the creep recovery of dough

The results of the creep recovery test by individual ingredient under a stress of 300 Pa are shown in FIG. 4. Deformation values in descending order are for: glycerol monolaurate, blank, gluconic acid-δ-lactone, calcium dihydrogen phosphate and alum; elasticity ratios in descending order are for: calcium dihydrogen phosphate (47.50%), alum (47.05%), glycerol monolaurate (34.42%), gluconic acid-δ-lactone (29.32%); yield stresses in descending order are for: gluconic acid-δ-lactone (6.65×10⁻⁴ Pa⁻¹), glycerol monolaurate (4.3×10⁻⁴ Pa⁻¹), calcium dihydrogen phosphate (2.8×10⁻⁴ Pa⁻¹), and alum (1.87×10⁻⁴ Pa⁻¹). Thus, the creep recovery of lactone-based dough can be matched to that of alum-based dough by adjusting the levels of gluconic acid-δ-lactone, calcium dihydrogen phosphate and glycerol monolaurate.

The invention also relates to the process for preparing a new type of aluminum-free fried fritter using the above-described frozen dough. The process has the following steps:

(I) Pouring the blended oil or other light oil into a frying pan and maintaining the temperature of the oil at 200° C. using a temperature controller.

The said blended oil is a kind of edible oil. Its main raw materials are selected from a group consisting of soybean oil, rapeseed oil, peanut oil, sunflower oil and cottonseed oil which are all refined. Two or more of the above refined oils are allocated in proportion and then deacidified, bleached, deodorized and blended, to produce the finished blended oil. The blended oil used in the present invention is commercially available.

The said light oil is a palm oil or olive oil with a low melting point. The palm oil and olive oil with low melting points are also commercially available.

The said temperature controller is a widely used temperature controlling device.

(II) Making blanks

Making the said dough into blanks 0.6-0.8 cm thick, and then cutting them into pieces 8-12 cm long and 2.0-3.0 cm wide; or making the said dough into blanks using a fritter blank continuous molding and jointing device.

The said fritter blank continuous molding and jointing device consists of a frame, with conveyors mounted on the table of the said frame driven by a motor and driving wheels, taking the traveling direction of the materials as the front. Two pressure mechanisms are installed in succession on the said frame, with carrying plates separately equipped above the pressure mechanisms. In front of the said pressure mechanisms are located an extrusion unit and a transverse cutting unit. A dusting unit is mounted after the pressure mechanisms, with two conical atomizing nozzles used to spray a solution that bonds two flour bands centered at the two pressure mechanisms. A thinning mechanism used to quickly thin the dough is located between the said extrusion unit and transverse cutting unit, along with a screw press roller between the said thinning mechanism and transverse cutting unit, and a flour recovery tank underneath the forefront of the said conveyors.

The said fritter blank continuous molding and jointing device is further described with reference to the accompanying drawings. As shown in FIG. 5-1, FIG. 5-2, FIG. 5-3, FIG. 5-4, FIG. 5-5, FIG. 5-6 and FIG. 5-7, two horizontal conveyors 2 and 3 in the same direction are mounted on the table of frame 1, and conveyor 2 is installed horizontally around drive wheels 54 and 30, of which wheel 30 is a driving wheel connected with a cycloid pin gear to motor 36 via transmission components, while wheel 54 is a driven wheel. Conveyor 3 is installed horizontally around drive wheels 55 and 34, where wheel 34 is a driving wheel and wheel 55 is a driven wheel.

Above conveyor 3 on frame 1, following the direction in which the conveyor travels, the dusting unit 21, lower blank pressure mechanism 18, conical atomizing nozzle 17, upper blank pressure mechanism 13, and smooth press roller 10 are mounted. The dusting unit is connected with drive wheel 34 of conveyor 3 through the belt, which can evenly release flour from the dusting unit, while hand wheel 22 within the said device can adjust the amount of flour released per unit time. The lower blank pressure mechanism has a press driving roll 57 and driven roll 56; between the two rolls is a carrying plate 19. The said carrying plate 19 is connected with frame 1 through the support frame 20. The drive roll 57 is connected with motor 32. As shown in FIG. 5-7, the conical atomizing nozzle 17 has a gas inlet 62, liquid inlet 60, driven valve inlet 61 and adhesive feeding hopper 16. The said nozzle is fixed on the support frame 58 of the said carrying plate by a lever bracket. The upper blank pressure mechanism 13 has the same structure as the lower blank pressure mechanism that is, it has a driving roll 59 and driven roll 60, with a carrying plate 23. The smooth press 10 is connected with a hand-rotating bolt 12 by a support bar 11.

As shown in FIGS. 5-3 and 5-4, on frame 1, a rapid thinning mechanism lies between conveyor 3 and conveyor 4, which comprises a hand wheel 37 used for adjusting the degree of suppression, extrusion roll 38, level driven small wheel 35, intake baffle 9, driving motor 36, fast driving wheel 39 and conveyor transmission connecting shaft 40.

Frame 1 is above conveyor 2. The twice-folded blank is rapidly transformed by the thinning mechanism 8. Following the direction in which the conveyor travels, the processing units are the screw press roller 7, transverse cutting unit 28 and butt joint device 52. Screw press roller 7 is connected with a hand-rotating mounting bolt 29 by a support bar 6. The transverse cutting unit 28 is as shown in FIG. 5-5, where the motor 3 is connected with clutch 4 by drive wheel 41, and the side output shaft of the clutch is connected with a connecting rod 45 through a double-hole wheel 42 (slide mechanism). The articulated slider 43 connected with the said connecting rod 45 moves back and forth inside the sleeve slideway 46 and thus enables the L-shape transverse blade 48 to complete the cutting operation. The said L-shape transverse blade 48 is fixed in the axial (vertical) direction by the blade positioning screw 49 and in the transverse direction moves up and down within the blade sliding screw locating slot 50 of the fixed baffle 51 by the blade sliding screw 47. The butt joint device 52 is as shown in FIG. 5-6, where it is fixed in the front of frame 1 and has a symmetrical notch 53 so that it can engage with the feeding device of the frying machine.

The above-described transverse cutting unit is fixed on the bracket 44 which is directly connected with the frame 1. In each of the motor and clutch layers, there is a horizontal hollow structure which allows the drive belt and connecting rod 45 to pass through and ensures that the structure can swing.

On the front of conveyors 3 and 2 are mounted flour recovery devices 31 and 26 which are used to recover the flour remaining on the dusting unit.

(III) Frying

Laying two blanks together with chopsticks pressing their center lengthwise, then lengthening them with a homogeneous force and placing them in a frying pan or FIR continuous fried fritter frying machine, from which the said fried fritters come out; or directly connecting the fritter blank continuous molding and jointing device with the FIR continuous fried fritter frying machine to execute the frying operation.

A frying pan is used to fry the fritters, such as type BZ-3 frying pan produced by Bixiang Kitchen Equipment Co. Ltd, Shanghai. When placed in the frying pan, preferably for 30-60 seconds, the fritters quickly swell and float. The fried fritters can be lightly manipulated by chopsticks to develop a uniform color in the pan, before being removed and strained to remove excess oil.

The said FIR continuous fried fritter frying machine consists of the body, an oil tank installed inside the said body, and the oil pocket system and control box integrated system connected to the said oil tank. The said oil tank is in a “boat” style and is located above the said body, along with a transmission-warming integrated device controlled by a hydraulic structure. A conveyor and chain-mode conveyor driven by a motor are installed inside the said integrated device, and the said conveyor equipped with an extruding roller to carry the fried fritters is installed around the head and end driving wheels of the transmission-warming integrated device. The said chain-mode conveyor is installed inside the transmission-warming integrated device and around two sets of wheels, and engages with the end socket gears of the extruding roller of the said conveyor. Infrared heating tubes and/or infrared heating plates are installed in the middle of the said chain-mode conveyor and an oil level sensor is located on the side of the “boat body”.

The automatic fritter-frying machine used in the present invention is further described with reference to the accompanying drawings. As shown in FIG. 6-1, FIG. 6-2, FIG. 6-3, FIG. 6-4, FIG. 6-5, FIG. 6-6 and FIG. 6-7, the automatic fritter-frying machine of the present invention mainly comprises three parts: an oil tank, oil pocket system and control box integrated system. The oil tank 1′ is in a “boat” style and is located above the said body; above oil tank 1′ is a transmission-warming integrated device 3′ which is controlled by a hydraulic structure 2′. Inside the said integrated device are two conveyors driven by motor 4′ which is mounted on the “bow”. One conveyor 5′ is installed around the driving wheels 6′ and 7′ of the transmission-warming integrated device, on which is installed an extruding roller 8′ for carrying fried fritters (see FIG. 6-6). Another chain-mode conveyor 9′ is mounted inside the transmission-warming integrated device and around driving wheels 10′ and 11′, with the conveyor between these two wheels engaging with the end socket gears 12′ of the extruding roller of the first conveyor. In the middle of the chain-mode conveyor are a set of infrared heating tubes 13′ and a set of far-infrared heating plates 14′. An oil level sensor 15′ is mounted at the appropriate place on the side of the “boat body”.

The said oil pocket system is installed in the lower left part of the body and comprises an oil pocket, oil circulating facility, oil filter and oil control valve. The oil pocket 16′ is mounted in the bottom of the said oil pocket system and connected with oil tank 1′ by a handle-operated three-way valve 17′. The oil circulating facility comprises an oil circulating pipe, pump 18′ and oil outlet three-way valve 19′. The said oil circulating pipe is connected with the inlet and outlet of pump 18′. The inlet pipe 20′ is connected with oil pocket 16′ and outlet pipe 21′ is connected with oil tank 1′ by three-way valve 19′. The pump 18′ is installed above oil pocket 16′ and below oil tank 1′. The oil filter 22′ is made of a negative-pressure hole single-chamber filter (metal material) and a trilateral closed filter jacket (composite non-woven cloth) and is located between the oil pocket 16′ and inlet pipe 20′ of pump 18′. The drain valve 23′ is set at the lower right side of the oil pocket 16′.

The said control box integrated system is mounted on the lower right side of the body.

In the operation, edible oil is poured into oil tank 1′. The level of oil covers the middle of the extruding roller gear 12′ which is engaged with chain-mode conveyor 9′ and is controlled by the oil level sensor 15′. The fritter blanks are fixed on the needle 25′ which is fused with extruding roller 8′, while a space reserved for finished fritters extends between the blanks and extruding roller 8′. Together with the first conveyor 5′, the fritter blanks move forward in a “revolution” movement around driving wheel 6′. When extruding roller gears 12′ engage with chain-mode conveyor 9′, with the operation of driving wheel 10′, the fritter blanks and extruding roller 8′ slowly rotate around the center of extruding roller 8′ as an “autobiographical” movement. The fritter blanks can roll themselves to imitate the hand-frying process until the fritter blanks and extruding roller 8′ move a cycle with conveyor 5′ and the blanks become fried fritters.

The condition of edible oil in the oil tank can be effectively controlled by adjusting the rod handle 26′ on the three-way valve 17′. When the rod handle 26′ is on the left and in the horizontal state, the three-way valve 17′ is closed and the tank is in a state of frying. When the rod handle 26′ is moved counterclockwise to the vertical state, the oil in the oil tank 1′ flows to the oil pocket 16′ and the tank is in a state of filtration. When the rod handle 26′ moves counterclockwise again to the right and horizontally, the oil in oil tank 1′ flows directly to the external container and the tank is in a discharge state.

The oil in the oil pocket can be recycled through the oil circulating and filtration system. When pump 18′ opens, a negative pressure will instantaneously form in inlet pipe 20′ and automatically absorb the oil filter to the nozzle and filter the oil entering the pipe. The condition of the filtered oil can be adjusted by controlling the three-way valve 19′ on the outlet pipe 21′. When the rod handle 27′ of the three-way valve 19′ is in the horizontal state, the oil filtered through oil pocket 16′ is pumped back to the oil tank 1′ and the tank is in a state of filtration. When the rod handle 27′ moves counterclockwise to the vertical state, the oil filtered through oil pocket 16′ is pumped to the external container or abandoned and the tank is in a discharge state.

We examined the quality of the aluminum-free microwaveable fried fritters of the present invention. The detection methods used are described below.

Experimental Methods

1. Moisture content was determined according to GB 5497-85.

2. Oil content was determined according to GB 5512-85.

3. The expansion rate (P) was determined as follows:

Put finished fried fritters into a graduated cylinder, pour rapeseed oil into the cylinder to submerge the fritters, and gently shake the container to ensure the fritters absorb enough oil, then read the total volume of the rapeseed oil and the finished fritters as V1. Remove the fritters with tweezers and read the volume of the rapeseed oil as V2. Calculate the expansion rate P according to the following equation:

Expansion rate P=(V1−V2)/V0

In which:

V0 is the volume of the finished fritters

V1 is the total volume of the rapeseed oil and the finished fritters

V2 is the total volume of the rapeseed oil after the fritters have been removed. Batches of five fried fritters were measured and used to calculate a mean value.

4. Determination of hardness

A British SMS TA.XTPlus Texture Analyzer TA.XT2i was used to determine hardness in the following conditions.

Each set of samples was measured seven times. The specific parameters used are shown in Table 5. The maximum and minimum values were removed and the average value taken.

TABLE 5
Parameter settings of the texture analyzer

| | |
|---|---|
| Probe: DPH-3PB | Testing rate: 50 mm/s |
| Radiesthesia: 10 g | Speed before testing: 50 mm/s |
| Testing distance: | Speed after testing: 50 mm/s |
| 70% (sample thickness) | |
| Initiation type: automatic | Acquisition rate: 200 pps |

5. Sensory evaluation

Indicators such as color, odor, microstructure and palatability were assessed and their criteria are listed in Table 6.

TABLE 6
Criteria for assessing the color, palatability,
odor and microstructure of the fried fritters

| Items | Criteria | Score |
|---|---|---|
| Color | Color and brightness of the fried fritters | 1-10 |
| | Gold | 8-10 |
| | Yellowish-white or brown | 4-8 |
| | White-gray or dark brown | 1-4 |
| Palatability | Crispness and toughness and resistance to chewing | 1-10 |
| | Crisp and refreshing, moderate tenacity | 8-10 |
| | Too soft, too hard or difficult to chew | 1-4 |
| | Middle | 4-8 |
| Odor | Aroma and taste | 1-10 |
| | Strong fried aroma and no odor | 8-10 |
| | Strong fried aroma with slight alkali or sour taste | 4-8 |
| | Heavy alkali or sour taste | 1-4 |
| Micro- | Size of the pores and uniformity and brittleness | 1-10 |
| structure | Homogeneous big pores and good brittleness | 8-10 |
| | Better uniformity of the pores or ordinary brittleness | 4-8 |
| | Bad uniformity of the pores or bad brittleness | 1-4 |

6. The orthogonal experiment was designed as shown in Table 7. The optimal formulations were determined by the orthogonal experiment.

TABLE 7
Level of components in the orthogonal experiment

| | Factors | | | |
|---|---|---|---|---|
| | | Gluconic | Calcium | |
| | Sodium | acid | dihydrogen | Glycerol |
| | bicarbonate | lactone | phosphate | monolaurate |
| Level | g/500 g flour | g/500 g flour | g/500 g flour | g/500 g flour |
| 1 | 3.5 | 0.6 | 0.6 | 0.6 |
| 2 | 4.0 | 0.8 | 0.8 | 0.7 |
| 3 | 4.5 | 1.0 | 1.0 | 0.8 |

7. Determination of microwave heating temperature curve

The temperature probe of a FISO microwave workstation was inserted in advance into different parts of the samples. Different heating power levels and times were selected to reheat the samples. The changes in temperature in the different parts were recorded in real time, repeated three times and then averaged with a recording frequency of 5 ms.

Experimental Results

On the basis of the above-described experiments, gluconic acid-δ-lactone, calcium dihydrogen phosphate, glycerol monolaurate and sodium bicarbonate were chosen as the four factors, with three levels per factor, for the orthogonal experiment. Sensory evaluation rated the color, odor, palatability and microstructure of the fried fritters. The results of the sensory evaluation are listed in Table 8. The physical and chemical properties measured are listed in Table 9.

TABLE 8
Orthogonal experiment - results of sensory evaluation

| | Odor | Color | Microstructure | Palatability | Overall |
|---|---|---|---|---|---|
| | Measured | Measured | Measured | Measured | assess- |
| Sample | values | values | values | values | ment |
| 1 | 7.33 | 4.22 | 5.67 | 5.00 | 5.61 |
| 2 | 7.56 | 4.67 | 5.89 | 5.67 | 6.00 |
| 3 | 7.22 | 5.56 | 6.67 | 6.56 | 6.52 |
| 4 | 7.33 | 6.22 | 7.56 | 7.00 | 7.03 |
| 5 | 5.44 | 6.56 | 7.00 | 6.67 | 6.37 |
| 6 | 6.89 | 7.11 | 7.67 | 7.22 | 7.20 |
| 7 | 6.22 | 7.67 | 7.67 | 6.89 | 7.08 |
| 8 | 5.67 | 7.67 | 7.56 | 7.44 | 7.03 |
| 9 | 5.56 | 7.33 | 7.44 | 7.78 | 6.97 |
| Alum | 7.01 | 7.23 | 6.83 | 7.25 | 7.08 |

TABLE 9
Orthogonal experiment - physical and chemical properties

| | Moisture | Expansion | Oil | Hardness |
|---|---|---|---|---|
| Sample | content (%) | rate (%) | content (%) | (g) |
| 1 | 31.988 | 4.190 | 9.49 | 2022 |
| 2 | 31.895 | 5.283 | 10.13 | 2151 |
| 3 | 31.586 | 5.464 | 11.00 | 2329 |
| 4 | 32.551 | 6.309 | 10.03 | 1510 |
| 5 | 28.989 | 5.996 | 11.09 | 1754 |
| 6 | 29.362 | 6.102 | 10.72 | 1933 |
| 7 | 25.550 | 6.040 | 10.85 | 1411 |
| 8 | 29.270 | 5.635 | 11.23 | 1848 |
| 9 | 27.360 | 5.881 | 11.40 | 1907 |
| alum | 25.803 | 6.130 | 19.71 | 2260 |

The overall results of the sensory evaluation were sorted in descending order by sample number: 6>7>alum>8>4>9>3>5>2>1. We then compared samples 6, 7 and 8 in terms of oil content: 8>7>6; moisture content: 6>8>7; expansion rate: 7>6>8; and hardness: 6>8>7.

TABLE 10
Results of the orthogonal experiment

| | Factors and codes | | | |
|---|---|---|---|---|
| | | | Calcium | |
| | Sodium | Gluconic | dihydrogen | Glycerol |
| | bicarbonate | acid-δ-lactone | phosphate | monolaurate |
| Average | A | B | C | D |
| K1 | 6.043 | 6.573 | 6.613 | 6.317 |
| K2 | 6.867 | 6.467 | 6.667 | 6.760 |
| K3 | 7.027 | 6.897 | 6.657 | 6.860 |
| Poor R | 0.984 | 0.430 | 0.054 | 0.543 |
| Best level | A3 | B3 | C2 | D3 |
| Priority | | A → D → B → C | | |
| of factors | | | | |

The overall results of the orthogonal experiment are listed in Table 10. The results of variance significance analysis are shown in Table 11. The priority of factors was determined to be A→D→B→C (see Table 10). The best combination was found to be A₃ B₃ C₂ D₃.

TABLE 11
Results of variance analysis

| | Sum of squared | Degree of | | |
|---|---|---|---|---|
| Factors | deviations | freedom | F value | Significance |
| Gluconic | 1.670 | 2 | 570 | 0.002 |
| acid-δ-lactone | | | | |
| Sodium bicarbonate | 0.301 | 2 | 3305 | 0.0001 |
| Calcium dihydrogen | 0.005 | 2 | 4163 | 0.0001 |
| phosphate | | | | |
| Monoglyceride | 0.502 | 2 | 1281 | 0.001 |

The 6^{th}, 7^{th} and 8^{th} (sample) results of the original orthogonal test and best combination of these were used in a verification test. The results of the verification test are listed in Table 12.

TABLE 12
Verification of the orthogonal test results

| | Moisture | | Oil | | | |
|---|---|---|---|---|---|---|
| | content | Expansion | content | | Overall | |
| Formulation tested | (%) | rate (%) | (%) | Hardness | assessment | |
| 6 | A3B1C2D2 | 29.432 | 6.004 | 10.72 | 1933 | 7.13 |
| 7 | A1B3C2D3 | 25.550 | 6.040 | 10.65 | 1411 | 7.12 |
| 8 | A2B1C3D2 | 29.270 | 5.635 | 11.23 | 1848 | 7.00 |
| Best | A3B3C2D3 | 29.521 | 6.051 | 10.03 | 1890 | 7.33 |
| combination | | | | | | |
| Alum | A | 25.803 | 6.130 | 19.71 | 2260 | 7.08 |
| formulation^{a} | | | | | | |

^{a}Alum 0.8 g; ammonium bicarbonate 7 g; sodium bicarbonate 2.25 g; calcium
dihydrogen phosphate 1.25 g (per 500 g of flour)

The best combination of A₃B₃C₂D₃ was found to be the best formulation overall.

Thus, fried fritters made from the dough of the present invention have very good sensory qualities. Compared to those made from the traditional alum formulation, the fried fritters made from the lactone-based dough have higher sensory values and a lower oil content, indicating they are of good quality and show promise in the further development of frozen pre-fried food.

Along with aluminum-free fried fritters, the dough of the present invention can be used to produce other frozen fried foods, such as Pai Cha, fried noodle fish, crackers, or fried dough twists.

In terms of microwave heating, the fried fritters were studied as follows. In the experiments, the temperature probe of the FISO microwave workstation was used to measure the temperature in the center and on the surface of the samples at different power levels and time intervals. Temperature curves were obtained in real time. The experiment was designed to monitor the temperature changes of the finished products in the range of (1) 900W heating, (2) 600W heating and (3) 440W heating; the results of the experiment are shown in FIG. 7.

With reference to FIG. 7, in the process of microwave heating, the temperature in the center of the fried fritters shows an S-shape curve, firstly heating up slowly, then warming rapidly before stabilizing at the highest temperature. During the period of stable temperature, the internal temperature raises the boiling point and moisture moves through the food which causes the outer layer to become wet. At higher microwave power levels, the rapid heating stage begins earlier and the slope of the rapid heating stage becomes steeper. The surface temperature of the fried fritters has a curve which shows first a gentle slope and then a rise; at higher microwave power levels, the starting point of the rising stage barely shifts but its slope becomes steeper.

The surface temperature curve and the center temperature curve of the fried fritters intersect; with increasing power, the temperature at the intersection tends firstly to rise and then to decline. According to the palatability principle, heating at 600W for 30 s can make the fritters' internal and external temperature reach 50° C. which is the food temperature most acceptable to human beings. This not only enables the fried fritters to directly reach the optimum temperature for consumption, but also avoids the wet sensation generated by internal moisture migration.

Therefore, the intersection of the internal and external temperature curves under each power setting indicates the best time in which to heat the food. Under the conditions thus determined, the samples were measured for their hardness and the results are listed in Table 13.

TABLE 13
The effect of different combinations of microwave power
and timing on the property of fried fritters

| | | | |
|---|---|---|---|
| Power (W) | 900 | 600 | 440 |
| Time (s) | 17 | 30 | 33 |
| Hardness | 1718 | 1740 | 1820 |
| Overall assessment | | | |
| (sensory | 6.64 | 7.31 | 6.92 |
| evaluation) | | | |

The results in Table 13 show that the hardness and overall assessment are better when samples are heated for 30 s at a power level of 600W. When heated for the longer time of 33 s at 440W, moisture fully migrates through the samples resulting in high levels of surface moisture. When heated for a shorter time of 17 s at 900W, the samples have a lower surface temperature. In the microwave heating process, a balance needs to be struck between the process of surface moisture evaporating to air and that of internal moisture migrating to the surface. Therefore, the microwave heating power and timing should be selected to ensure that the speed of moisture migration is less than that of evaporation on the surface, which can reduce the surface's degree of wetting. Table 13 shows that the above-mentioned result can be achieved by heating for 30 s at 600W.

[Beneficial Effects]

The present invention has the following advantages.

The use of gluconic acid-δ-lactone, glycerol monolaurate and calcium dihydrogen phosphate rather than alum as acidic components in the leavening agent can reduce the toxicity and improve the reliability of the dough. Using a farinograph, extensorgraph and rheology to establish the optimum level of each individual ingredient, we have produced a dough with virtually identical properties to conventional dough made with alum. By optimizing the parameters of the production process, we manufactured fried fritters with a good expansion rate and crispy texture, meeting customers' needs for quality microwaveable products. The processing of the present invention is simple and convenient, and can thus be expanded to tap into the microwaveable food market with good economic benefits.

### BRIEF DESCRIPTION OF THE DRAWINGS

FIG. 1 is the effect of all ingredients on the composite modulus (G*) of dough.

FIG. 2 is the effect of individual ingredients on the composite modulus (G*) of dough.

FIG. 3 is the effect of all ingredients on the creep recovery of dough.

FIG. 4 is the effect of individual ingredients on the creep recovery of dough.

FIG. 5 is the schematic diagram of the fritter blank continuous molding and jointing device, in which FIG. 5-1 is a schematic diagram of the structure; FIG. 5-2 is the top view of FIG. 5-1; FIG. 5-3 is a schematic diagram of the thinning mechanism; FIG. 5-4 is the top view of FIG. 5-3; FIG. 5-5 is a schematic diagram of the transverse cutting unit; FIG. 5-6 is a schematic diagram of the butt joint device and the diagram of its top view; FIG. 5-7 is a schematic diagram of the structure of the conical atomizing nozzle.

In the figures: 1. frame; 2. conveyor; 3. conveyor; 4. clutch; 6. support bar; 7. screw press roller; 8. thinning mechanism; 9. intake baffle; 10. smooth press roller; 11. support bar; 12. hand-rotating mounting bolt; 13. upper blank pressure mechanism; 16. adhesive feeding hopper; 17. conical atomizing nozzle; 18. lower blank pressure mechanism; 19. carrying plate; 20. support frame; 21. dusting unit; 22. hand wheel; 23. carrying plate; 26. flour recovery device; 28. transverse cutting unit; 29. hand-rotating mounting bolt; 30. driving wheel; 31. flour recovery device; 32. motor; 33. motor; 34. driving wheel; 35. level driven small wheel; 36. driving motor; 37. hand wheel; 38. extrusion roll; 39. quick driving wheels; 40. conveyor transmission connecting shaft; 41. driving wheel; 42; double-hole wheel; 43. articulated slider; 44. bracket; 45. connecting rod; 46. sleeve slideway; 47. blade sliding screw; 48. L-shape transverse blade; 49. blade positioning screw; 50. blade sliding screw locating slot; 51. fixed baffle; 52. butt joint device; 53. symmetrical notch; 54. driving wheel; 55. driving wheel; 56. driven roll; 57. driving press roll; 58. support frame; 59. driving roll; 60. driven roll; 61. driven valve inlet; 62. gas inlet.

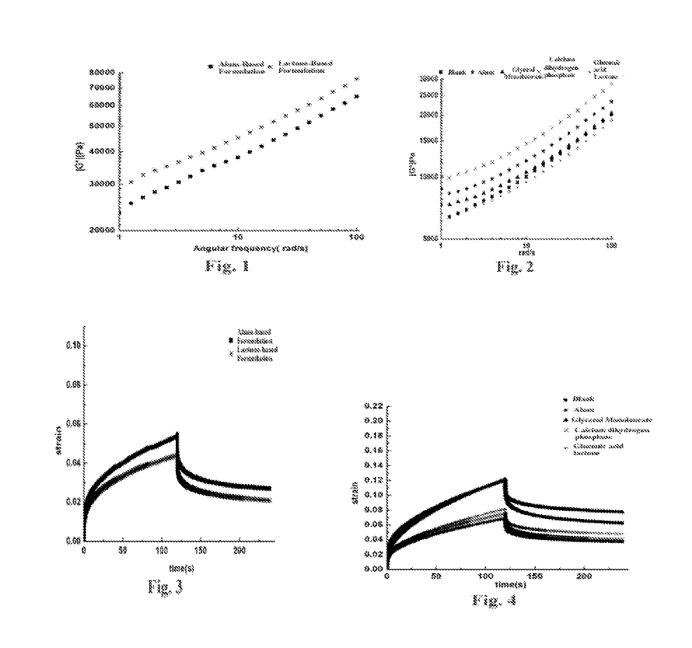

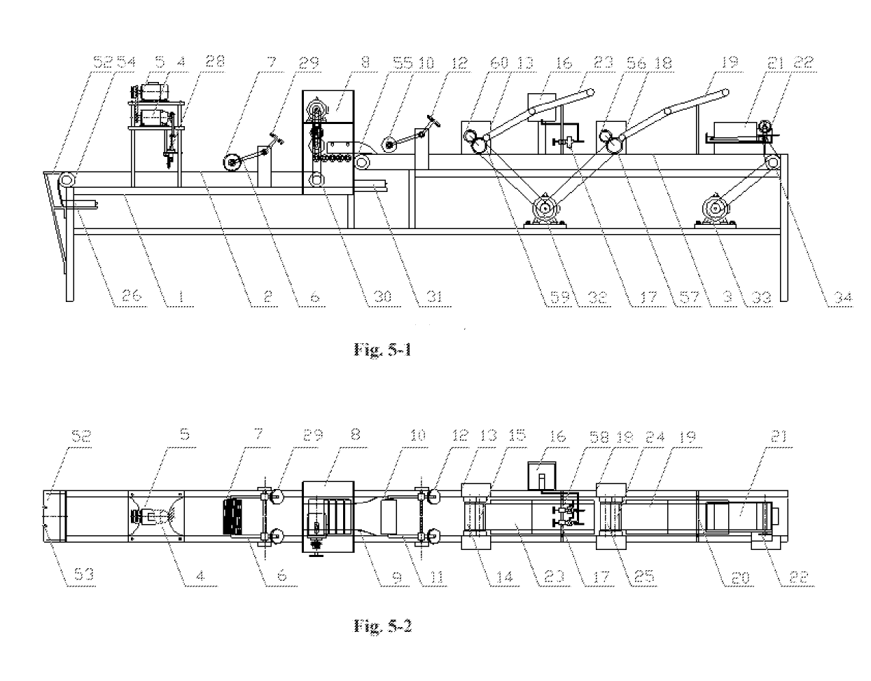

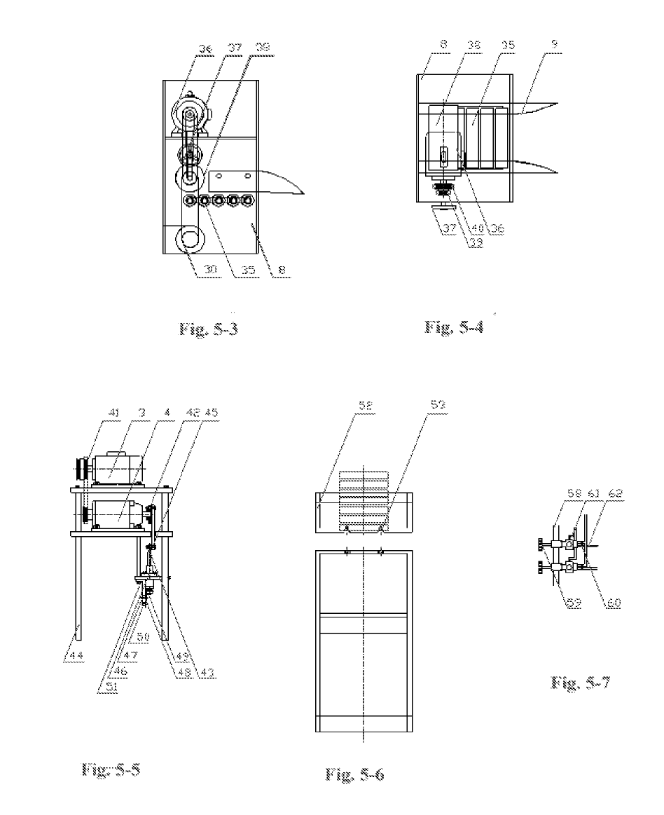

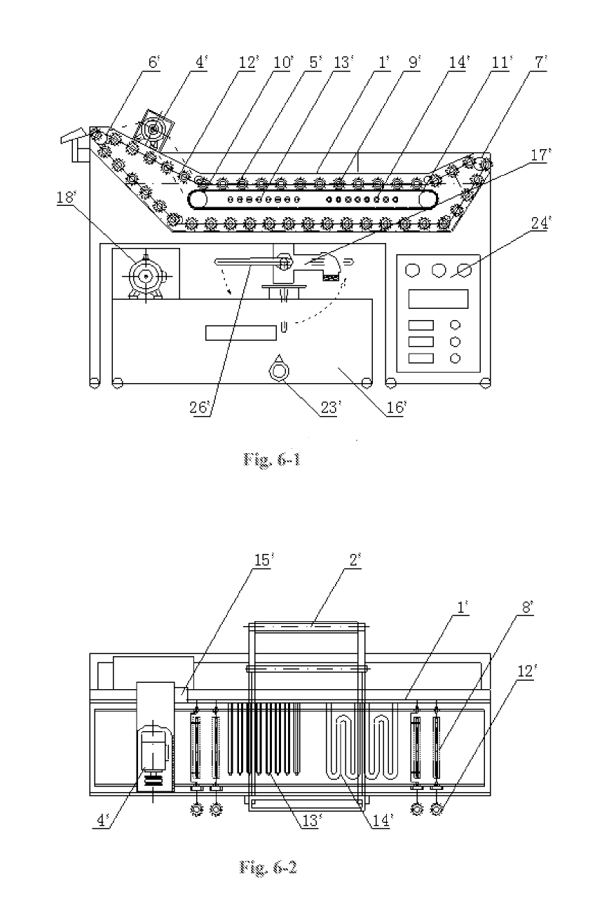

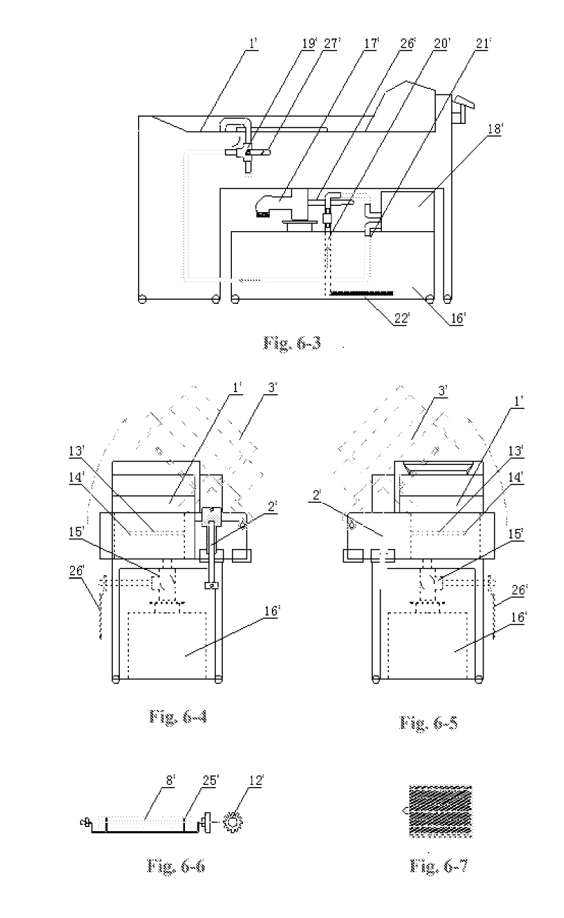

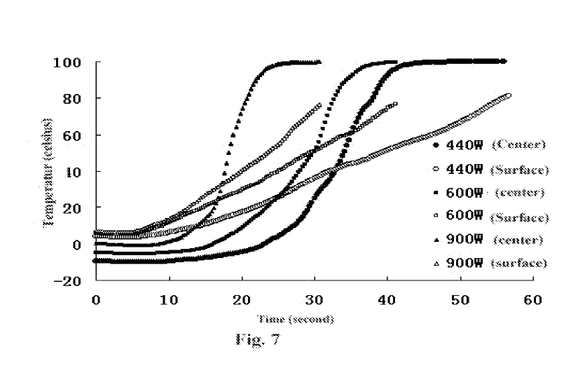

FIG. 6 is the schematic diagram of the FIR continuous fried fritter frying machine, in which FIG. 6-1 is the schematic diagram of its structure; FIG. 6-2 is its top view; FIG. 6-3 is its rear view; FIG. 6-4 is its right view; FIG. 6-5 is its left view; FIG. 6-6 is the schematic diagram of the structure of the extruding roller; FIG. 6-7 is the schematic diagram of the structure of the oil filter.

In the figures: 1′. oil tank; 2′. hydraulic structure; 3′. cover of the tank; 4′. motor; 5′. conveyor; 6′. driving wheel; 7′. driving wheel; 8′. extruding roller; 9′. chain-mode conveyor; 10′. front driving wheel; 11′. back driving wheel; 12′. end socket gears; 13′. infrared heating tubes; 14′. far-infrared heating plates; 15′. oil level sensor; 16′. oil pocket; 17′. three-way valve; 18′. pump; 19′. oil outlet three-way valve; 20′. inlet pipe; 21′. outlet pipe; 22′. oil filter; 23′. drain valve; 24′. control box integrated system; 25′. needle; 26′. rod handle; 27′. control handle.

FIG. 7 is the figure of the microwave heating characteristics of fried fritters.

### SPECIFIC EMBODIMENTS

### Example 1

### Preparing a Dough According to the Process of the Present Invention

The implementing steps of the example are as following:

(I) Disposal of Raw Materials

By weight, accurately weighing and adding 0.6 parts gluconic acid-δ-lactone, 0.6 parts calcium dihydrogen phosphate, 3.5 parts sodium bicarbonate and 8 parts sodium chloride to 29 parts water at around 40° C., to obtain an aqueous phase; then adding 0.6 parts glycerol monolaurate to 12.5 parts rapeseed oil and stirring to dissolve it completely, to obtain an oil phase; subsequently adding the said oil phase to the aqueous phase and quickly stirring with an agitator for 3 min to obtain a liquid mixture.

(II) Dough Kneading

After mixing the raw materials, by weight, weighing 500 parts flour, and adding the liquid mixture obtained in step (I) three times to the flour, then stirring and mixing for 5 min to obtain a smooth, springy and sticky dough.

(III) Dough Proofing for the First Time

Sealing the dough obtained in step (II) with plastic wrap, then placing it in a proofer by Zhangqiu City Luxing Machine Works at a temperature of 40° C. to proof for 1.0 hour.

(IV) Dough Folding

Folding the proofed dough obtained in step (III) from two sides to the center, then rotating it by 90° and folding again, and repeating the operation 10 times.

(V) Dough Proofing for the Second Time

Sealing the dough obtained in step (IV) with plastic wrap, then placing it in the said proofer for 2 hours, and the proofed dough being directly used for subsequent processing of the fried fritter.

To illustrate the effects of using dough prepared by this process, we fried fritters made with conventional and lactone-based dough and compared the results as follows.

The process for preparing the said fried fritters comprises the following steps:

(a) Pouring commercially available edible blended oil into a frying pan and maintaining the temperature of the oil at 200° C. using a ZNHW-II precise temperature controller.

(b) Making blanks

Making the said proofed dough into blanks 0.7 cm thick, and then cutting them into pieces 10 cm long and 2.5 cm wide.

(c) Frying

Laying two blanks together with chopsticks pressing their center lengthwise, then lengthening them to about 20 cm with a homogeneous force and placing them in a type BZ-3 frying pan produced by Bixiang Kitchen Equipment Co. Ltd, Shanghai, so that the blanks rapidly expand and float during frying. The fritters can be stirred and turned over with chopsticks to make them homogeneously expand and change color; after frying for 45 s, the said fried fritters can be taken out and strained to remove excess oil.

(d) Cooling

The fried fritters obtained by frying are strained for 3 min in a sieve to remove excess oil, then transferred to a precooling tunnel at a temperature of 20° C. and wind speed of 200 m/min to be cooled for 30 min.

(e) Quick-freezing

After cooling, the fried fritters are transferred to the quick-freezing room at a temperature of −35° C. by a conveyor to be rapidly frozen in 5-10 min; when the temperature of their center falls below −18° C., the fried fritters are deemed frozen and preserved at a temperature of −20° C.

The moisture content, expansion rate, oil content and hardness of the fried fritters were then determined. The results are shown in Table 15. Moisture content was determined according to GB 5497-85. Oil content was determined according to GB 5512-85. Hardness was measured with a TA-XT2i texture analyzer, whose settings are listed in Table 14.

TABLE 14
Parameter settings of the texture analyzer

| | |
|---|---|
| Probe: DPH-3PB | Testing rate: 5.0 mm/s |
| Radiesthesia: 10 g | Speed before testing: 5.0 mm/s |
| Testing distance: 70% (sample thickness) | Speed after testing: 5.0 mm/s |
| Initiation type: automatic | Acquisition rate: 200 pps |

Determination of the expansion rate and overall assessment of the fried fritters was carried out according to the methods described in previous sections of this application.

In the same way as for the example, fried fritters were prepared using conventional dough. The moisture content, expansion rate, oil content and hardness of the fried fritters were determined. The results are listed in Table 15.

TABLE 15
Comparison of performance of fried fritters
prepared using lactone-based
dough and conventional dough

| | Moisture | Expansion | Oil | Hard- | Overall |
|---|---|---|---|---|---|
| | content | rate | content | ness | assess |
| Lactone-based dough | 29.521 | 6.051 | 10.03 | 1890 | 7.33 |
| Conventional dough | 25.803 | 6.130 | 19.71 | 2260 | 7.08 |

Table 15 shows that the quality of the new type of aluminum-free fried fritters prepared using the dough of the present invention is better than that prepared using the conventional dough. The results of sensory evaluation show that the fried fritters prepared using the lactone-based dough have more acceptable sensory qualities, along with a higher moisture content, lower hardness, lower oil content and so on.

### Example 2

### Preparing the Fried Fritters According to the Process of Present Invention

This example is carried out in the same way as for Example 1, except that the dough obtained in step (VI) is quick-frozen at −40° C., then placed in a refrigeration room at a temperature of −18° C. to preserve it for 24 h, then thawed at a temperature of 4° C. for 18 h, and finally placed in a proofer by Zhangqiu City Luxing Machine Works at a relative humidity of 75% to proof.

The moisture content, expansion rate, oil content and hardness of the fried fritters were determined, and the results are shown in Table 16.

### Example 3

### Preparing the Fried Fritters According to the Process of Present Invention

This example is carried out in the same way as for Example 1, but using by weight 1.0 parts gluconic acid-δ-lactone, 1.2 parts calcium dihydrogen phosphate, 5.4 parts sodium bicarbonate, 9.0 parts sodium chloride, 298 parts water at a temperature of 40° C., 0.8 parts glycerol monolaurate and 13.0 parts rapeseed oil.

The moisture content, expansion rate, oil content and hardness of the fried fritters were determined, and the results are shown in Table 16.

### Example 4

### Preparing the Fried Fritters According to the Process of Present Invention

This example is carried out in the same way as for Example 1, but using by weight 0.9 parts gluconic acid-δ-lactone, 0.8 parts calcium dihydrogen phosphate, 4.5 parts sodium bicarbonate, 9.5 parts sodium chloride, 300 parts water at a temperature of 40° C., 0.6 parts glycerol monolaurate and 12.8 parts peanut oil.

The moisture content, expansion rate, oil content and hardness of the fried fritters were determined, and the results are shown in Table 16.

### Example 5

### Preparing the Fried Fritters According to the Process of Present Invention

This example is carried out in the same way as for Example 1, but using by weight 0.75 parts gluconic acid-δ-lactone, 0.85 parts calcium dihydrogen phosphate, 4.4 parts sodium bicarbonate, 9.2 parts sodium chloride, 285 parts water at a temperature of 40° C., 1.2 parts glycerol monolaurate and 12.4 parts peanut oil.

The moisture content, expansion rate, oil content and hardness of the fried fritters were determined, and the results are shown in Table 16.

### Example 6

### Preparing the Fried Fritters According to the Process of Present Invention

This example is carried out in the same way as for Example 1, but using by weight 0.85 parts gluconic acid-δ-lactone, 0.92 parts calcium dihydrogen phosphate, 4.0 parts sodium bicarbonate, 8.2 parts sodium chloride, 295 parts water at a temperature of 40° C., 0.75 parts glycerol monolaurate and 12.8 parts peanut oil.

The moisture content, expansion rate, oil content and hardness of the fried fritters were determined, and the results are shown in Table 16.

TABLE 16
Comparison of performance of fried fritters
prepared with lactone-based and conventional
dough using the methods in Examples 1 to 6

| | Moisture | | Oil | | |
|---|---|---|---|---|---|
| | content | Expansion | content | Hard- | Overall |
| | (%) | rate (%) | (%) | ness | asessment |
| Example 2 | 29.521 | 6.051 | 10.07 | 1830 | 7.39 |
| Example 3 | 29.801 | 6.130 | 10.35 | 2040 | 7.28 |
| Example 4 | 30.210 | 6.012 | 10.78 | 1750 | 7.12 |
| Example 5 | 27.358 | 5.931 | 11.50 | 1796 | 7.03 |
| Example 6 | 28.950 | 5.720 | 11.04 | 1829 | 7.15 |
| Conventional dough | 25.803 | 6.130 | 19.71 | 2260 | 7.08 |

Table 16 shows that the oil content and hardness of the fried fritters prepared with lactone-based dough (Examples 1-6) are significantly superior to those of the fried fritters prepared using conventional dough, while the expansion rates are similar. These results demonstrate that quality of the fried fritters prepared by the process of the present invention is excellent, and can perfectly satisfy consumer' demands in terms of taste and flavor. Thus, our process offers a viable alternative to alum-based dough, increasing the safety of fried fritters and paving the way for further development of traditional fried food.

1. A composition of frozen dough consists of gluconic acid-δ-lactone:sodium bicarbonate:glycerol monolaurate:calcium dihydrogen phosphate:edible oil: sodium chloride:flour:water at ratio by 0.8-1.0:3.5-5.0:0.8-1.0:0.8-1.0:12.0-13.0:8.0-10.0:480-520:280-300 by weight, said frozen dough is manufactured by following steps:
(I) Disposal of raw materials
Mixing said gluconic acid-δ-lactone, said calcium dihydrogen phosphate, said sodium bicarbonate and said sodium chloride with said water to obtain an aqueous phase at around 40° C.; then adding said glycerol monolaurate to said edible oil and stirring to dissolve it completely, to obtain an oil phase; subsequently adding said oil phase to said aqueous phase and stirring for 1-5 min to obtain a liquid mixture;
(II) Dough kneading
Adding said liquid mixture into said flour by three or four times, then stirring and mixing for 3-8 min to obtain smooth, springy and sticky dough;
(III) Dough proofing for the first time
Sealing said sticky dough with plastic wrap, then placing it in a proofing box for proofing for 0.8-1.2 hours at 40° C.;
(IV) Dough folding
Folding said proofed dough obtained in step (III) from two sides to center, then rotating it by 90° and folding again, and repeating the operation 8 to 12 times;
(V) Dough proofing for the second time Sealing said folded dough obtained in step (IV) with plastic wrap, then placing it in a proofing box to proof for additional 1.6-2.4 hours at 40° C., then freezing the dough.

2. The composition of frozen dough according to claim 1, said frozen dough consists of said gluconic acid-δ-lactone:said sodium bicarbonate:said glycerol monolaurate:said calcium dihydrogen phosphate:said edible oil:said sodium chloride:said flour:said water at ratio by 1.0:4.5:0.8:0.8:12.5:9.0:500:290 by weight.

3. The composition of frozen dough according to claim 1, characterized in that the freezing in said step (V) refers to rapid freezing of the proofed dough at is a temperature of less than −40° C. before preserving at a temperature between −10 and −30° C.

4. The composition of frozen dough according to claim 1, characterized in that said frozen dough is thawed for 16-20 hours at 4° C. and then proofed in a proofing box at a temperature of 27-29° C. and relative humidity of 70-75%.

5. The composition of frozen dough according to claim 1, characterized in that said frozen dough is proofed directly in a proofing box at a temperature of 27-29° C. and relative humidity of 70-75%.

6. The composition of frozen dough according to claim 1, said frozen dough is used as microwaveable food.

7. The composition of frozen dough according to claim 6, said microwaveable food is fried fritter.

8. A process for manufacturing frozen dough to be used as microwaveable food comprises following steps:
(I) Disposal of raw materials
By weight, accurately weighing and mixing 0.6-1.0 parts of gluconic acid-δ-lactone, 0.6-1.2 parts of calcium dihydrogen phosphate, 3.5-5.5 parts of is sodium bicarbonate and 8-10 parts of sodium chloride to 280-300 parts of water at around 40° C., to obtain an aqueous phase; and mixing 0.6-1.2 parts of glycerol monolaurate to 12.0-13.0 parts of edible oil and stirring to dissolve it completely, to obtain an oil phase; then adding the said oil phase to said aqueous phase and stirring for 1-5 min to obtain a liquid mixture;
(II) Dough kneading
Adding said liquid mixture to 480-520 parts of flour by three or four times, then stirring and mixing for 3-8 min to obtain a smooth, springy and sticky dough;
(III) Dough proofing for the first time
Sealing the sticky dough obtained in step (II) with plastic wrap, then placing it in a proofing box to proof for 0.8-1.2 hours at 40° C.;
(IV) Dough folding
Folding the proofed dough obtained in step (III) from two sides to the center, then rotating it by 90° and folding again, and repeating the operation 8 to 12 times;
(V) Dough proofing for the second time
Sealing the dough obtained in step (IV) with plastic wrap, then placing it in a proofer at 40° C. to proof for the second time for 1.6-2.4 hours, and the proofed dough being directly used for subsequent processing, or frozen to preserve it then thawed prior to subsequent processing.

9. The process according to claim 8, characterized in said frozen dough consists of said gluconic acid-δ-lactone:said sodium bicarbonate:said glycerol monolaurate:said calcium dihydrogen phosphate:said edible oil:said sodium chloride:said flour:said water at ratio by 1.0:4.5:0.8:0.8:12.5:9.0:500:290 by weight.

10. The process according to claim 8, characterized in that the freezing in step (V) refers to rapid freezing of the proofed dough at a temperature of less than −40° C. before preserving at a temperature between −10 and −30° C.

11. The process according to claim 8, characterized in that said frozen dough is thawed for 16-20 hours at 4° C. and then proofed in a proofing box at a temperature of 27-29° C. and relative humidity of 70-75%.

12. The process according to claim 8, characterized in that said frozen dough is thawed for 16-20 hours at 4° C. and then proofed in a proofing box at a temperature of 27-29° C. and relative humidity of 70-75%.

13. A process for preparing an aluminum-free fried fritter comprises following steps:
(I) Pouring blended oil or other light oil into frying pan and maintaining is temperature of oil at 200° C. with a temperature controller;
(II) Making blanks
Making a frozen dough into blanks 0.6-0.8 cm thick, and then cutting them into pieces 8-12 cm long and 2.0-3.0 cm wide; or making said dough into blanks using a fritter blank continuous molding and jointing device;
(III) Frying
Laying two blanks together with chopsticks pressing their center lengthwise, then lengthening them with a homogeneous force and placing them in a frying pan, or far-infrared (FIR) continuous fried fritter frying machine from which the said fried fritter will come out, or directly connecting the fritter blank continuous molding and jointing device with the FIR continuous fried fritter frying machine to execute the frying operation.

14. The process according to claim 13, characterized in that said fried fritters are placed for 3 min in a sieve or grid conveyor to remove excess oil, transferred to a pre-cooling tunnel or room at a temperature of 20° C. and at wind speed of 200 m/min for cooling for 30 min, then t transferred to a to quick-freezing room at a temperature between −30° C. and −50° C. or a quick-freezing tunnel at a temperature of less than −30° C. over 5-10 min; when the temperature of middle of inside of said fried fritters being below −18° C., storing them at a temperature between −10 and −40° C.

15. The process according to claim 13, said frozen dough is the same as the frozen dough of claim 1.

16. The process according to claim 13, said frozen dough is manufactured by the process of claim 6.

17. The process according to claim 13, characterized in that said fritter blank continuous molding and jointing device consists of a frame with conveyors mounted on the table of said frame driven by a motor and driving wheels, taking the traveling direction of the materials as forward direction; two pressure mechanisms, equipped with carrying plates separately, being installed in succession on said frame; in the front of said pressure mechanisms being mounted an extrusion unit which is mounted a transverse cutting unit at its front; in the back of said pressure mechanisms being mounted a dusting unit, in the center of said pressure mechanisms being mounted with two conical atomizing nozzles to spray a solution that bonds two flour bands; a thinning mechanism, being used to quickly thin the dough, being mounted between said extrusion unit and said transverse cutting unit; a screw press roller being mounted between said thinning mechanism and said transverse cutting unit; and a flour recovery tank underneath the forefront of the said conveyors.

18. The process according to claim 13, characterized in that said FIR is continuous fried fritter frying machine consists of a body, an oil tank installed inside said body, and an oil storage system and control box integrated system being connected to said oil tank; said oil tank being in a “boat” style and being mounted above said body; a transmission-warming integrated device, controlled by a hydraulic structure, being mounted above said oil tank; the conveyor and chain-mode conveyor driven by a motor being installed inside said integrated device, and said conveyor equipped with an extruding roller to carry the fried fritters being installed around the head and end driving wheels of said transmission-warming integrated device; said chain-mode conveyor being installed inside said transmission-warming integrated device and around two sets of driving wheels, and engaging with the end socket gears of said extruding roller of said conveyor; infrared heating tubes and/or infrared heating plates being installed in the middle of said chain-mode conveyor and an oil level sensor being located on the side of said “boat body”.
